(19) United States
(12) Patent Application Publication
(10) Pub. No.: US 2016/0141816 A1
(43) Pub. Date: May 19, 2016

(54) ELECTRICAL CONNECTOR STRUCTURE

(71) Applicant: SPEED TECH CORP., Taoyuan City (TW)

(72) Inventors: Hui-Hsueh CHIANG, Taoyuan City (TW); Chien-Yu HSU, Taoyuan City (TW)

(21) Appl. No.: 14/937,894

(22) Filed: Nov. 11, 2015

(30) Foreign Application Priority Data
Nov. 17, 2014 (TW) 103220429

(51) Int. Cl. H01R 24/60

(52) U.S. Cl. CPC H01R 24/60

(57) ABSTRACT

An electrical connector structure electrically connected to a docking connector and a cable. The electrical connector structure includes a plurality of first conductive terminals, a plurality of second conductive terminals, an insulating housing, and a metal housing. Each of the first conductive terminals has a first end portion and two first contact portions. Each of the second conductive terminals has a second end portion and a second contact portion. The insulating housing has a plurality of terminal grooves respectively receiving the first conductive terminals and the second conductive terminals. The metal housing substantially covers the exterior of the insulating housing. With the foregoing design, the structure of the whole product can be simplified, and the production costs can be reduced.

### RELATED APPLICATIONS

This application claims priority to Taiwan Application Serial Number 103220429, filed Nov. 17, 2014, which is herein incorporated by reference.

### BACKGROUND

1. Technical Field

The present disclosure relates to an electrical connector structure, and more particularly, to the electrical connector structure assembled by a plurality of first conductive terminals, a plurality of second conductive terminals, an insulating housing, and a metal housing.

2. Description of Related Art

Currently, the trends of demand for an electronic device are to have a minimum volume and maximum functions, so the assembly space in the electronic device must be efficiently used by electronic components. That is, the demand for high-density electronic components is increasing. In general, the manufacturing efficiency of a high-density electrical connector is often ignored. As shown in FIG. 8 and FIG. 9, the figures illustrate a high-density electrical connector discloses by Taiwan Patent Number M344636. The patent discloses that each of conductive terminals A at least extends a pair of first interfere wings C and a pair of second interfere wings B, the first interfere wings C of each of the conductive terminals A respectively extend toward supporting surfaces of corresponding receiving channels D, and the second interfere wings B of each of the conductive terminals A respectively extend away from supporting surfaces of corresponding receiving channels D.

In the disclosure of the above-mentioned patent, when the high-density electrical connector operates, configurations of the conductive terminals A might be different owing to functional differences. With reference to FIG. 9, due to functional requirements of the high-density electrical connector, the conductive terminals A must be arranged side-by-side. Under the circumstances, the assembling procedures are complicated. Furthermore, each of the conductive terminals A having a special design increases the manufacturing and processing procedures and is not conduct to automated mass production, so a high-density electrical connector is a necessity to be improved.

### SUMMARY

A purpose of the disclosure is to provide an electrical connector structure, and more particularly, to provide the electrical connector structure assembled by a plurality of first conductive terminals, a plurality of second conductive terminals, an insulating housing, and a metal housing, so as to simplify whole product and reduce the production costs.

In order to achieve the foregoing purpose, the disclosure provides an electrical connector structure electrically connected to a docking connector and a cable. The electrical connector structure includes a plurality of first conductive terminals, a plurality of second conductive terminals, an insulating housing, and a metal housing. Each of the first conductive terminals has a first end portion and two first contact portions, the contact portions are electrically connected to the docking connector, and the first end portion is electrically connected to the cable. Each of the second conductive terminals has a second end portion and a second contact portion, the second contact portion is electrically connected to the docking connector, and the second end portion is electrically connected to the cable. The insulating housing has a plurality of terminal grooves for respectively receiving the first conductive terminals and the second conductive terminals. The metal housing substantially covers an exterior of the insulating housing.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of an electrical connector structure according to an embodiment of the disclosure;

FIG. 2 is an exploded view of the electrical connector structure according to an embodiment of the disclosure;

FIG. 3 is a perspective view showing certain components of the electrical connector structure according to an embodiment of the disclosure;

FIG. 4 is a cross-sectional view of the electrical connector structure according to an embodiment of the disclosure;

FIG. 5 is a perspective view showing certain components of the electrical connector structure according to an embodiment of the disclosure;

FIG. 6 is a cross-sectional view of the electrical connector structure according to an embodiment of the disclosure;

FIG. 7 is a perspective view showing certain components of the electrical connector structure according to an embodiment of the disclosure;

FIG. 8 is a structural diagram of Taiwan Patent Number M344636; and

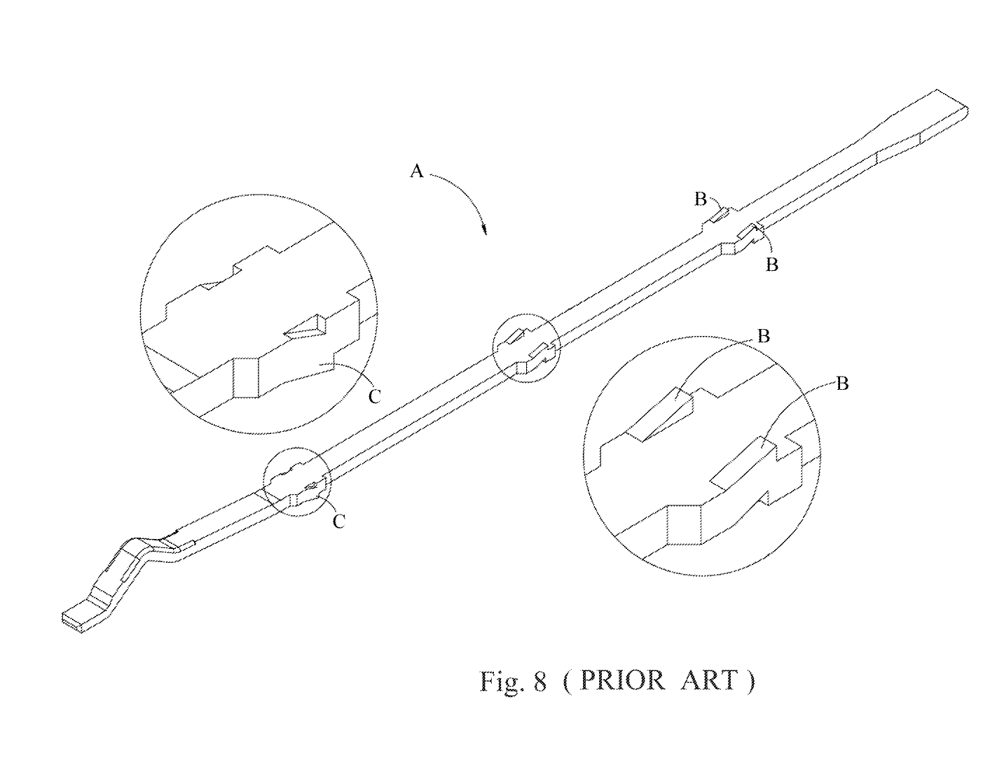

FIG. 9 is another structural diagram of Taiwan Patent Number M344636.

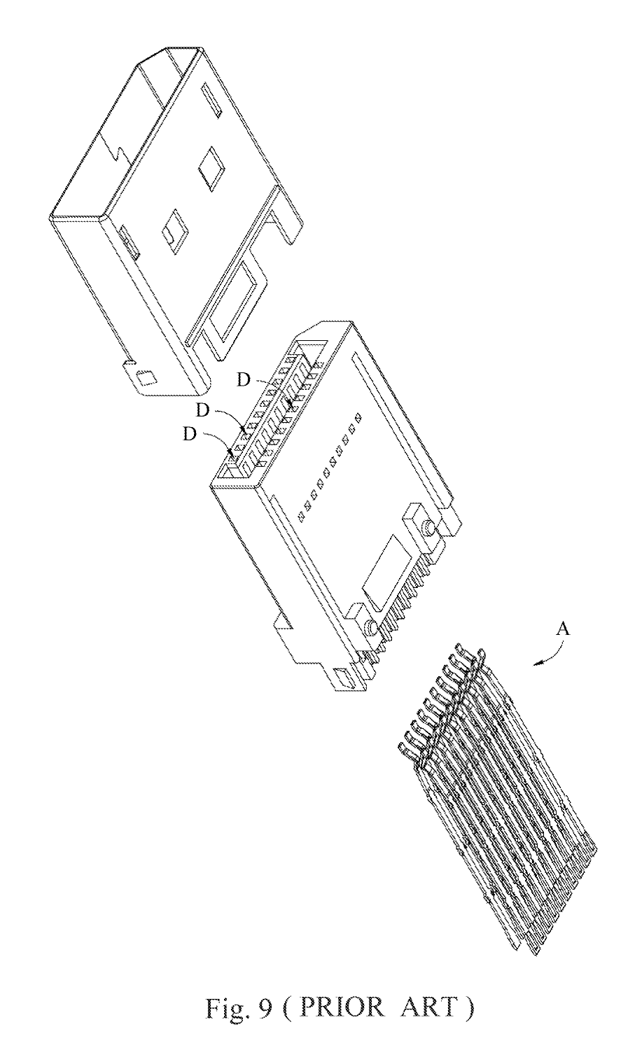

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

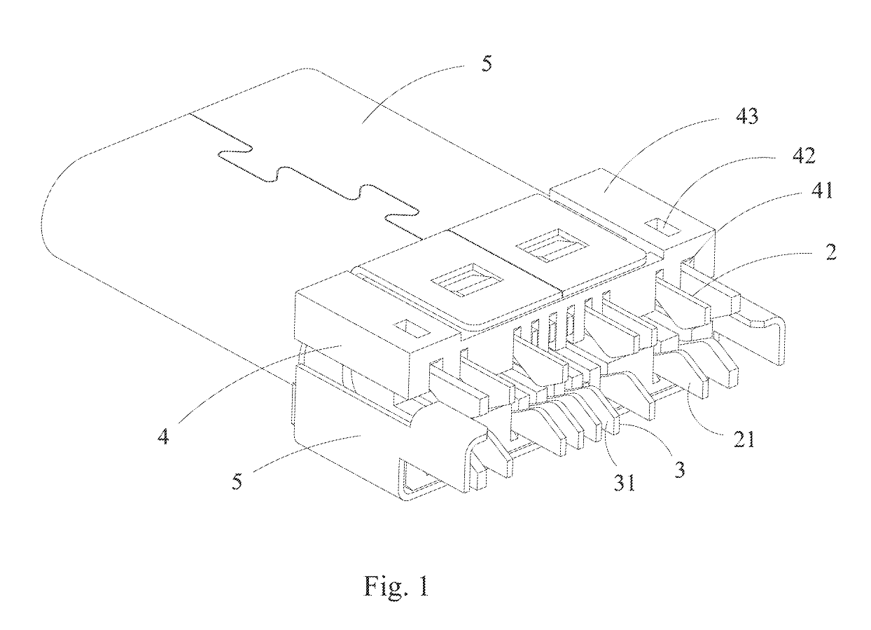

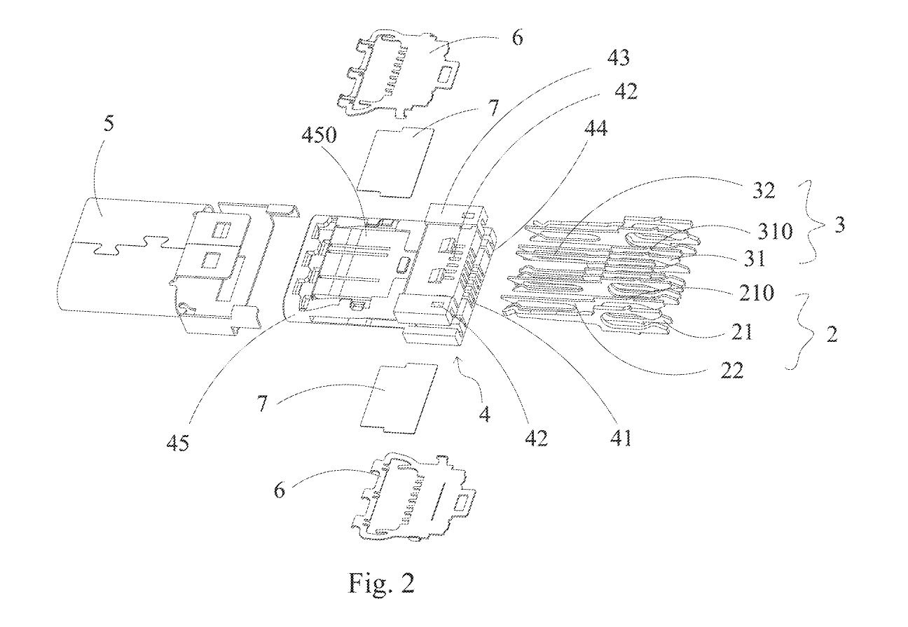

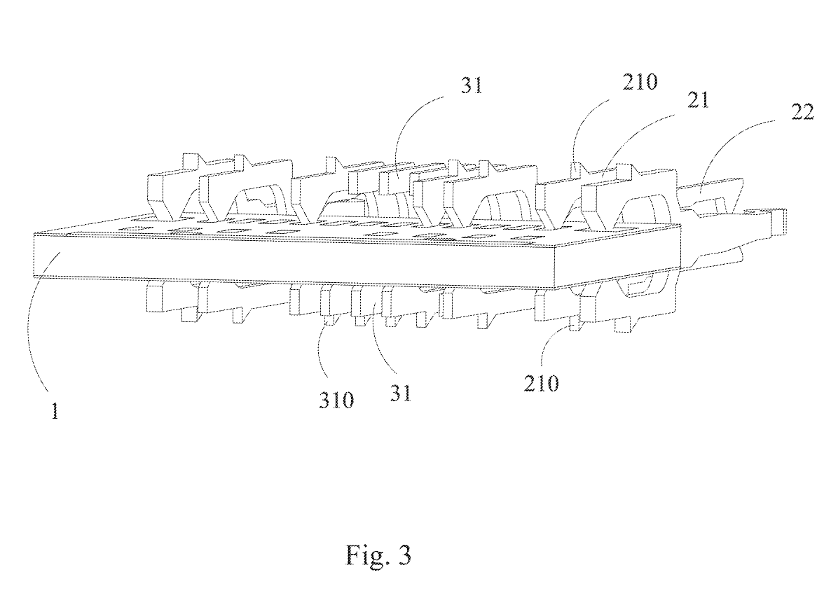

As shown in FIG. 1 to FIG. 7, the electrical connector structure of the disclosure is electrically connected to a docking connector (not shown) and a cable (not shown). The electrical connector structure includes a plurality of first conductive terminals 2, a plurality of second conductive terminals 3, an insulating housing 4, and a metal housing 5. Each of the first conductive terminals 2 has a first end portion 21 and two first contact portions 22. The contact portions 22 are electrically connected to the docking connector. The first end portion 21 is electrically connected to the cable. In the embodiment, the first end portion 21 is electrically connected to an end of a circuit board 1 (as shown in FIG. 3), and another end of the circuit board 1 is electrically connected to the cable, so as to electrically connect the first end portion 21 and the cable. Each of the second conductive terminals 3 has a second end portion 31 and a second contact portion 32. The second contact portion 32 is electrically connected to the docking connector. The second end portion 31 is electrically connected to the cable. In the embodiment, the second end portion 31 is electrically connected to an end of the circuit board 1 (as shown in FIG. 3), and another end of the circuit board 1 is electrically connected to the cable, so as to electrically connect the second end portion 31 and the cable. The insulating housing 4 having a plurality of terminal grooves 41 for respectively receiving the first conductive terminals 2 and the second conductive terminals 3. The metal housing 5 substantially covers an exterior of the insulating housing 4.

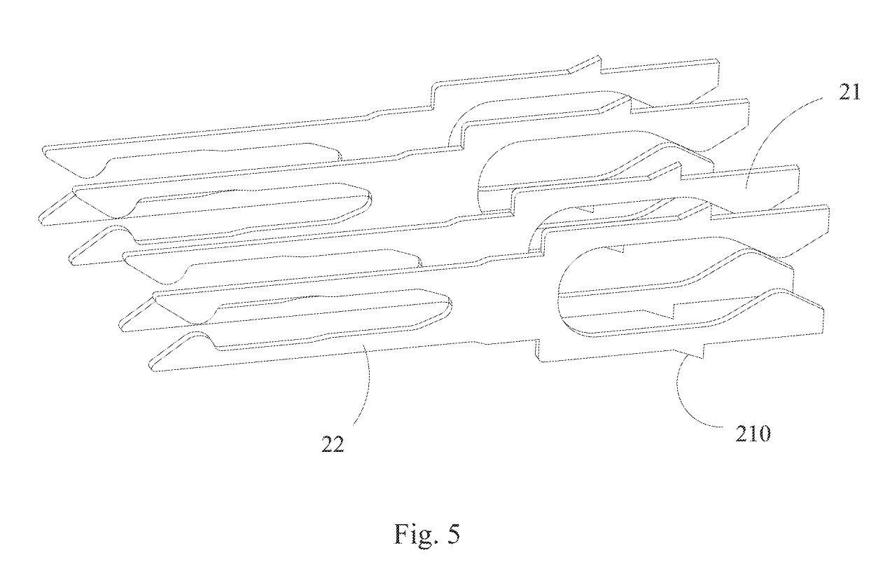

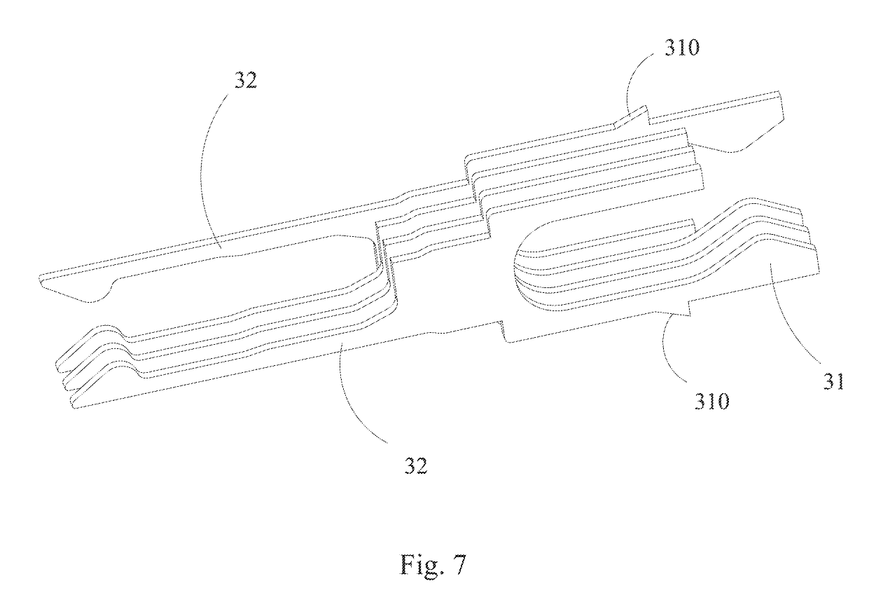

In the foregoing electrical connector structure, the first end portion 21 of each of the first conductive terminals 2 is U-shaped, and two protruding portions 210 are respectively disposed at two U-shaped side handles of the first end portion 21. The second end portion 31 of each of the second conductive terminals 3 is substantially U-shaped, and a protruding portion 310 is disposed at a U-shaped side handle of the second end portion 31. The protruding portions 210, 310 are triangular protrusions, but the disclosure is not limited in this regard. (as shown in FIG. 5 and FIG. 7)

In the foregoing electrical connector structure, the insulating housing 4 has a plurality of recess portions 42, a first surface 43, a second surface 44, and a docking portion 45. The second surface 44 is opposite to the first surface 43. The recess portions 42 are formed at the first surface 43 and the second surface 44. In the embodiment, the recess portions 42 are vertical wells extended from the first surface 43 and the second surface 44 to the terminal grooves 41, so as to be communicated with the terminal grooves 41. The triangular protrusions of the first end portion 21 and the triangular protrusions of the second end portion 31 are respectively engaged with the vertical wells. Both of the two opposite surfaces of the docking portion 45 have a recessed zone 450.

The foregoing electrical connector structure further has a pair of metal pieces 6 and a pair of patches 7. The patches 7 are respectively attached to the recessed zones 450. The metal pieces 6 are respectively attached to the recessed zones 450, and the metal pieces 6 are electrically connected to the metal housing 5. The patches 7 are respectively located at front surfaces of the metal pieces 6, so as to define a positioning window for positioning the docking portion 45. In the embodiment, the patches 7 are polyester films, such as Mylar films, but the disclosure is not limited in this regard. In other embodiments, the patches 7 can also be Kapton films.

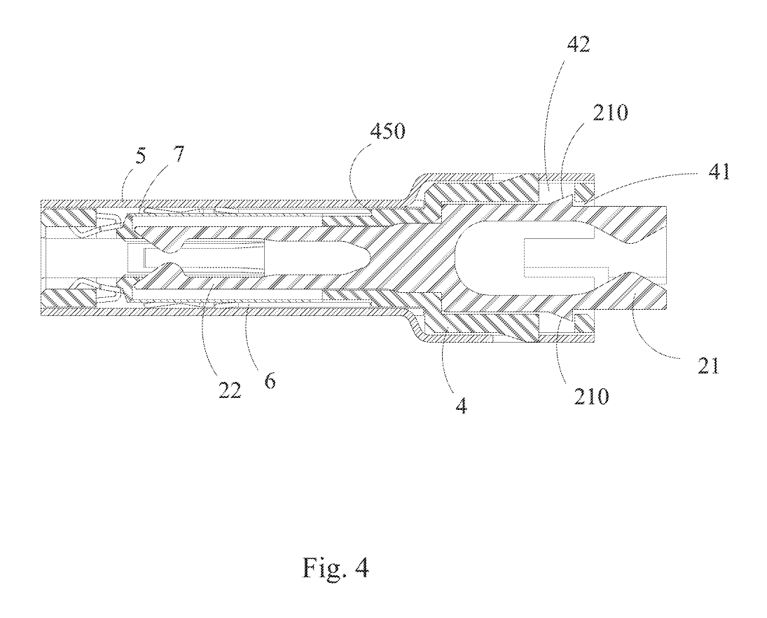

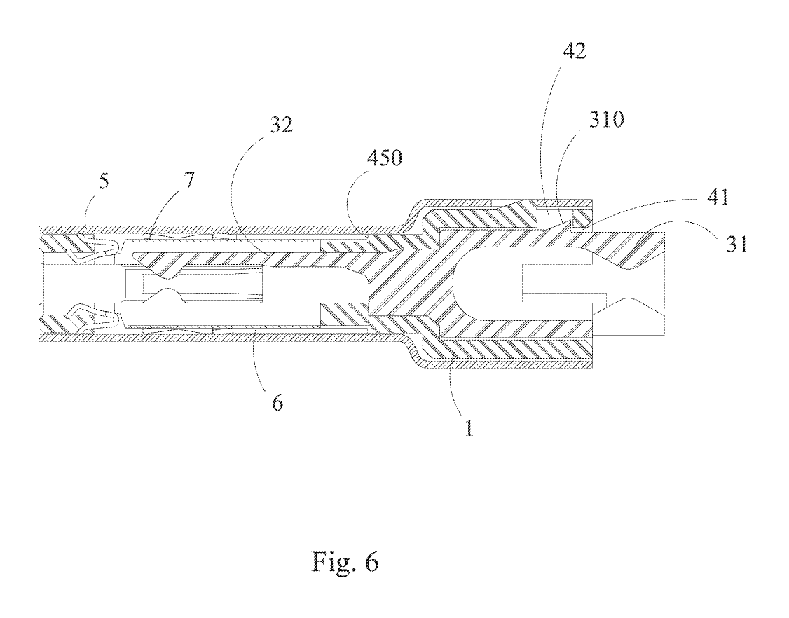

In the foregoing electrical connector structure, when the first conductive terminals 2 and the second conductive terminals 3 are respectively positioned in the terminal grooves 41, the first conductive terminals 2 and the second conductive terminals 3 can be firmly fixed in the terminal grooves 41 because the triangular protrusions are respectively engaged with the vertical wells. Therefore, the first conductive terminals 2 and the second conductive terminals 3 can be prevented from leaving the terminal grooves 41 (as shown in FIG. 4 and FIG. 6).

The first end portions 21 of the first conductive terminals 2 extend out of the insulating housing 4 to electrically connect the circuit board 1 in a clamping way. The electrical connections not only can be implemented by abutting the first end portions 21 to the circuit board 1, but also can be implemented by welding the first end portions 21 to the circuit board 1. In the embodiment, the first end portions 21 of the first conductive terminals 2 are electrically connected to the cable via the circuit board 1, but the disclosure is not limited in this regard. In practical applications, the first end portions 21 can be directly welded to the cable without using the circuit board 1. The second end portions 31 of the second conductive terminals 3 extend out of the insulating housing 4 to electrically connect the circuit board 1 directly. The electrical connections not only can be implemented by abutting the second end portions 31 to the circuit board 1, but also can be implemented by welding the second end portions 31 to the circuit board 1. In the embodiment, the second end portions 31 of the second conductive terminals 3 are electrically connected to the cable via the circuit board 1, but the disclosure is not limited in this regard. In practical applications, the second end portions 31 can be directly welded to the cable without using the circuit board 1. When connecting to a docking connector (not shown), the first contact portions 22 of the first conductive terminals 2 are electrically connected to the docking connector in clamping way, and the second contact portions 32 of the second conductive terminals 3 are electrically connect the docking connector directly.

Accordingly, with the design assembled by the first conductive terminals 2, the second conductive terminals 3, the insulating housing 4, and the metal housing 5, signal transmissions can be achieved, the components with simple structures are suitable for mass production. Furthermore, the collocation of the first conductive terminals 2 and the second conductive terminals 3 can be adjusted according to functional requirements, so as to reduce processing procedures and production costs.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A electrical connector structure electrically connected to a docking connector and a cable, the electrical connector structure comprising:
a plurality of first conductive terminals, each of the first conductive terminals has a first end portion and two first contact portions, wherein the contact portions are electrically connected to the docking connector, and the first end portion is electrically connected to the cable;
a plurality of second conductive terminals, each of the second conductive terminals has a second end portion and a second contact portion, wherein the second contact portion is electrically connected to the docking connector, and the second end portion is electrically connected to the cable;
an insulating housing having a plurality of terminal grooves for respectively receiving the first conductive terminals and the second conductive terminals; and
a metal housing substantially covering an exterior of the insulating housing.

2. The electrical connector structure of claim 1, wherein both of the first end portion and the second end portion have at least one protruding portion interfered with the insulating housing.

3. The electrical connector structure of claim 2, wherein the first end portion is U-shaped, and the protruding portion is disposed at a U-shaped side handle of the first end portion.

4. The electrical connector structure of claim 2, wherein the protruding portion is a triangular protrusion.

5. The electrical connector structure of claim 2, wherein the insulating housing has a plurality of recess portions respectively communicated with the terminal grooves, and the protruding portions of the first conductive terminals and the protruding portions of the second conductive terminals are respectively engaged with the recess portions.

6. The electrical connector structure of claim 5, wherein the insulating housing has a first surface, and the recess portions are formed at the first surface.

7. The electrical connector structure of claim 5, wherein the insulating housing has a first surface and a second surface correspond to the first surface, and the recess portions are formed at the first surface and the second surface.

8. The electrical connector structure of claim 1, wherein the insulating housing has a docking portion, and both of two opposite surfaces of the docking portion have a recessed zone.

9. The electrical connector structure of claim 8, further having a pair of metal pieces respectively attached to the recessed zones, and the metal pieces are electrically connected to the metal housing.

10. The electrical connector structure of claim 8, further having a pair of patches respectively attached to the recessed zones.

11. The electrical connector structure of claim 10, wherein the patches are polyester films.
